(19) United States
(12) Patent Application Publication
(10) Pub. No.: US 2026/0290855 A1
(43) Pub. Date: Sep. 24, 2026

(54) Busbar Arrangement, and Fuel Cell

(71) Applicant: Bayerische Motoren Werke Aktiengesellschaft, Muenchen (DE)

(72) Inventors: Michael GUNKEL, Hoergertshausen (DE); Patrik LOFERER, Oberschleissheim (DE); Marco ZOESCH, Vaterstetten (DE)

(21) Appl. No.: 19/478,044

(22) PCT Filed: Apr. 24, 2024
(86) PCT No.: PCT/DE2024/100365

§ 371 Date: Oct. 23, 2025

(30) Foreign Application Priority Data
Apr. 24, 2023 (DE) 10 2023 110 394.6

(51) Int. Cl. H01M 8/0267; H01M 8/0206; H01M 8/0232; H01M 8/026; H01M 8/04007; H01M 8/2465

(52) U.S. Cl. CPC H01M 8/0267; H01M 8/0206; H01M 8/0232; H01M 8/026; H01M 8/04074; H01M 8/2465

(57) ABSTRACT

A busbar arrangement includes a busbar and a conduit system for conducting a cooling medium to the busbar. Also disclosed is a fuel cell comprising a fuel cell stack and at least one busbar arrangement.

### BACKGROUND AND SUMMARY

The technology disclosed here relates to a busbar arrangement, in particular for a fuel cell, and to a fuel cell.

Fuel cells are typically used to convert gaseous or liquid fuel directly into electricity. For this purpose, they typically have electrodes that are separated from one another by a membrane or another ion-conducting medium. Current is in this case generated directly by electrochemical reactions. This current is typically led off via one or more busbars so that it can be fed to a consumer. In this way, for example, electricity may be generated from hydrogen or another fuel, by which an electric motor that powers a motor vehicle can be operated.

It has been found that busbars may be subjected to heating because of the heavy currents flowing through them.

It is a preferred object of the technology disclosed here to reduce or to eliminate at least one disadvantage of a previously known solution or to propose an alternative solution. It is in particular a preferred object of the technology disclosed here to provide a busbar arrangement that has improved cooling. Further preferred objects may be inferred from the advantageous effects of the technology disclosed here. The objects are achieved by the subject matter disclosed herein. The present disclosure also represents preferred embodiments.

The technology disclosed here relates to a busbar arrangement, comprising (i) a busbar and (ii) a line system for delivering a coolant to the busbar. The busbar may therefore be cooled by the coolant. This can improve the current-carrying capacity of the busbar; in particular, overheating can be avoided. In particular, the busbar arrangement may be a busbar arrangement for a fuel cell. In principle, however, it may also be a busbar arrangement for a different application. The delivery to the busbar may, in particular, involve the coolant coming into contact with the busbar. The coolant is typically conveyed actively, in particular by a pump.

The busbar may, in particular, be an element that is suitable for carrying a current, in particular a relatively heavy current of for example several amperes, several hundred amperes, more than a thousand amperes or several thousand amperes. In particular, it is thereby possible to transport a current that is intended to be carried from a current source, for example a fuel cell or a generator, or from a high-voltage storage unit, to a consumer. The line system may, in particular, be configured to deliver the coolant to the busbar in such a way that it comes into contact with the busbar. In particular, the delivery of the coolant may take place continuously so that continuous heat dissipation from the busbar can take place.

According to one embodiment, the busbar has a recess, the line system being configured to deliver the coolant through the recess. The coolant can therefore be fed through the recess in the busbar. This can enable release of heat from the busbar to the coolant on all sides. A plurality of recesses may also be used. Alternatively or in addition, there may also be a flow around it. A recess is configured, in particular, as a passage through the busbar. Typically on sides to which no line is connected, i.e. the line system is not connected, the recess is fully enclosed by material of the busbar.

The recess may, in particular, be filled with a porous material. The latter can allow passage of the coolant. It may, in particular, be thermally coupled to the rest of the busbar. In particular, the effective surface area for the heat transport may thereby be increased significantly. A porous material is, in particular, a material that contains walls which enclose pores. The pores are advantageously joined to one another so that the coolant can pass through. The walls in this case represent contact areas with the coolant, so that overall a substantially larger contact area with the coolant is achieved than when a recess that is for example rectangular in cross section is provided without containing porous material. The recess may be fully or partially filled with the porous material.

In particular, the porous material may be a metal foam. In particular, a copper foam may be used. Such materials and embodiments have been found to be particularly advantageous. In particular, they can be produced easily.

In particular, the porous material may for example be formed from the same material as an area surrounding the recess. That is to say, for example, a busbar may be formed from copper and the copper foam in the recess may also be generated with the same copper during the production of the busbar.

The recess may, in particular, have a rectangular cross section. This allows a simple embodiment, particularly in the case of a flat busbar. Other cross sections, such as round or oval, are however also possible in principle. The recess may be configured as an elongate channel. The residence time of the coolant in the busbar may thereby be increased. An elongate channel may, in particular, be characterized in that it is longer than the greatest extent in its cross section.

In particular, the busbar may be formed from copper. This allows easy production as well as good transport of current and heat. In principle, other materials may however also be used, for example aluminum or silver.

According to one embodiment, the busbar arrangement has a pump for pumping the coolant through the busbar. By such a pump, the coolant may be moved actively. It can therefore advantageously dissipate heat.

According to one advantageous embodiment, the busbar arrangement has a heat exchanger for dissipating heat from the coolant. A heat flow may therefore be generated in such a way that the heat is initially released from the busbar to the coolant and is in turn released from the coolant to the heat exchanger.

The heat exchanger may, for example, ensure that the heat is released further to a surrounding area or to a superordinate cooling circuit. In particular, the heat exchanger may be an active component around which a medium that can absorb and dissipate the heat from the coolant actively flows.

According to one embodiment, a passive cooling device is formed in the line system. This may, for example, be a heat pipe. In this way, it can be provided that heat dissipation takes place without active intervention, for example to a heat exchanger. According to one embodiment, a pump may then be obviated. Alternatively, a pump may nevertheless also be provided, however, so that, for example, minor thermal loads can be dissipated passively and higher thermal loads can be dissipated by using the pump.

In particular, the coolant may be liquid. It may, however, also be gaseous. Hybrids may also be used.

In particular, the coolant may be a dielectric medium. A dielectric medium is distinguished in particular in that it has no free charge carriers and/or has a conductivity of at most 5 μS/cm or at most 10 μS/cm. This prevents a short circuit and/or an undesired flow of current via the coolant.

According to one advantageous embodiment, the busbar arrangement has an ion exchanger for adjusting and/or reducing a conductivity of the coolant. This makes it possible to achieve a situation in which the conductivity of the coolant may be adjusted and/or reduced so that no current is dissipated via the coolant. The formation of undesired short circuits can be prevented in this way.

In particular, the busbar arrangement may have a conductivity measuring instrument for measuring a conductivity of the coolant. The conductivity of the coolant may therefore be monitored. For example, it can be provided that an ion exchanger is activated when the conductivity exceeds a predefined threshold value. This may, for example, be implemented in an associated control device.

The technology disclosed here further relates to a fuel cell, comprising (i) at least one fuel cell stack as well as (ii) at least one busbar arrangement as described here, wherein the fuel cell stack is electrically connected to the busbar of the busbar arrangement. The advantages already mentioned further above for a busbar arrangement described here may therefore be made usable for a fuel cell. In respect of the busbar arrangement, all embodiments and variants described here may be employed.

A fuel cell is, in particular, designed to convert the chemical energy of a fuel into different forms of energy, in particular into electrical energy. A fuel cell is intended, for example, for mobile applications such as motor vehicles (for example automobiles, motorcycles, commercial vehicles), in particular to provide the energy for at least one prime mover for powering the motor vehicle. In its simplest form, a fuel cell is an electrochemical energy converter that converts fuel (for example hydrogen) and oxidant (for example air, oxygen and peroxides) into reaction products and in the process produces electricity and heat.

A heat pipe may in particular be a heat-transfer device that passively transports heat by using the latent heat of vaporization of a medium. In other words, a heat pipe is an element that stores a substance which at least partially experiences a phase transition in order to transport heat. Such a heat pipe may be configured differently and is known per se to a person skilled in the art. Advantageously, with such a heat pipe a comparatively large heat flow can be transferred with a comparatively low thermal resistance. In the present case, such a heat pipe may in particular be implemented in the line system.

In other words, it is known in principle that busbars in a fuel cell stack and DC-DC converters tend to have a rather large and/or heavyweight design. In the previous embodiments, inter alia relatively high thermal loads occur, which require an even larger cross section (more material, more installation space). Furthermore, largely constructed busbars are relatively heavy. By the use of materials such as for example copper metal foam, it is possible to integrate heat management and/or a heat exchanger, so that the required material cross section can be reduced in comparison to an uncooled embodiment.

In particular, a busbar is proposed with active cooling (for example a heat exchanger comprising Cu foam), an integrated heat exchanger/integrated heat management in busbars. By the active integrated cooling by very highly thermally conductive copper foam or other embodiments, the heat can be dissipated substantially better so that the cross section of the busbars can be reduced. This does not affect the current-carrying capacity.

The technology disclosed here is described below with the aid of the figures.

### BRIEF DESCRIPTION OF THE DRAWINGS

FIG. 1 shows a busbar arrangement,

FIG. 2 shows a part of the busbar arrangement, and

FIG. 3 shows the part of the busbar arrangement of FIG. 2 in a different view.

### DETAILED DESCRIPTION OF THE DRAWINGS

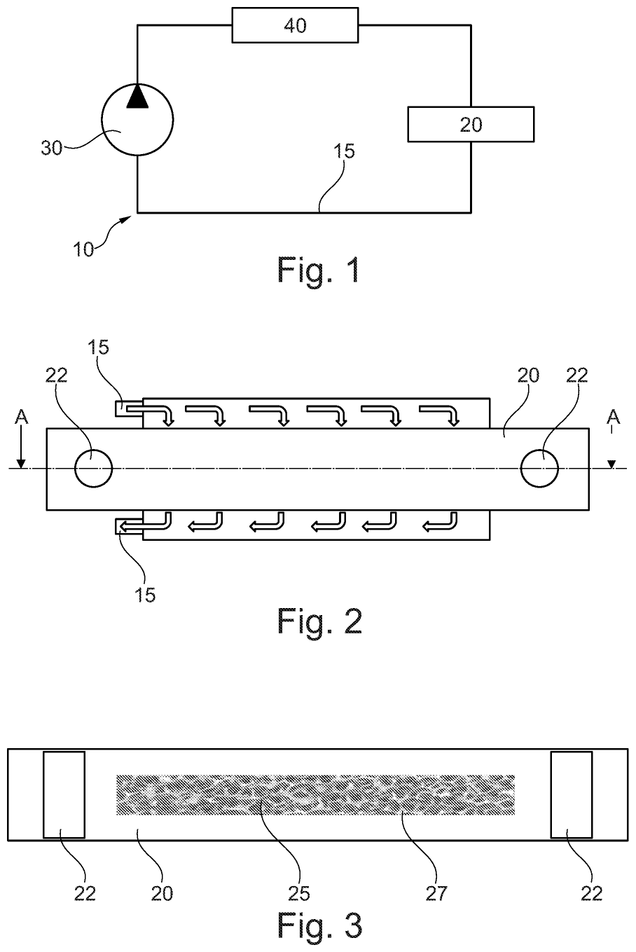

FIG. 1 purely schematically shows a busbar arrangement 10 according to one exemplary embodiment. The busbar arrangement 10 has a busbar 20. The latter can be used in a manner not shown in further detail to carry current, for example inside a fuel cell. The busbar arrangement 10 has a line system 15, which is configured to convey a coolant. By way of example, a liquid coolant is used, for example water, although other coolants may also be used, in particular liquid or gaseous coolants.

The busbar arrangement 10 has a pump 30, which is configured to pump the coolant in the circuit. The busbar arrangement 10 further has a heat exchanger 40, through which the pump 30 pumps the coolant. In the heat exchanger 40, heat can be released from the coolant. For this purpose, for example, the airstream due to driving flows around the heat exchanger 40 or the latter is joined to a superordinate cooling circuit (not represented). As shown, after passing through the heat exchanger 40, the coolant is pumped through the line system 15 to the busbar 20. There, the coolant can thus absorb heat and thereby cool the busbar 20.

FIGS. 2 and 3 show the busbar 20 in a more detailed representation in cross section. FIG. 3 is a cross-sectional view of the section plane A-A indicated in FIG. 2 from a different side. In the embodiment shown, there are two connecting points 22 which are used for connection to a fuel cell arrangement or another apparatus. In principle, it is also possible to use only one connecting point, for example. Connecting points may, for example, be used in order to connect the busbar to a current collector plate of a fuel cell and/or to a DC/DC converter. It is also possible to connect a further busbar. The busbar 20 in the present case is formed from copper, which enables good current transport as well as good heat transport.

As shown, the line system 15 is connected to the busbar 20 so that the coolant passes through the busbar 20. For this purpose, as represented in FIG. 3, the busbar 20 has a recess 25 through which the line system 15 delivers the coolant.

The recess 25 is filled with a porous material 27. In the present case, the latter is a copper foam. This porous material 27 may thus be produced integrally with the rest of the busbar 21. The porous material 27 has a multiplicity of pores that are joined to one another and make it possible for the coolant to pass through and in the process come into contact with the porous material 27 along a very large surface area. In comparison to an unfilled recess 25, this allows a significant increase in the surface area that can be used for the heat transfer and thereby ensures significantly improved heat exchange between the coolant and the busbar 20. If the busbar 20 is heated because of current flowing through, it is thus cooled effectively by the coolant, the heat ultimately being released to the heat exchanger 40 and from there into the surroundings or to a superordinate cooling circuit.

Overall, the embodiment described here can thus provide a busbar 20 that can be cooled purposely and thus achieve the same current-carrying capacity with a lower weight than an uncooled busbar.

For reasons of readability, the expression “at least one” was sometimes omitted for simplicity. If a feature of the technology disclosed here is described in the singular or indefinitely (for example the/a busbar, the/a fuel cell stack, etc.) its plural is also meant to be disclosed at the same time (for example the at least one busbar, the at least one fuel cell stack, etc.).

The preceding description of the present disclosure serves only for illustrative purposes and not for the purpose of restricting the disclosure. Various changes and modifications are possible in the framework of the present disclosure without departing from the scope of the present disclosure and of its equivalents.

### LIST OF REFERENCE SIGNS

10 busbar arrangement
15 line system
20 busbar
22 connecting points
25 recess
27 porous material
30 pump
40 heat exchanger

1-13. (canceled)

14. A busbar arrangement comprising:
a busbar; and
a line system configured to deliver a coolant to the busbar,
wherein the busbar comprises a recess, and wherein the line system is configured to deliver the coolant through the recess, and
wherein the recess is filled with a porous material configured to allow passage of the coolant and that is thermally coupled to the rest of the busbar.

15. The busbar arrangement according to claim 14,
wherein the porous material is a metal foam.

16. The busbar arrangement according to claim 14,
wherein the porous material is a copper foam.

17. The busbar arrangement according to claim 14,
wherein the recess has a rectangular, round, or oval cross section and/or is configured as an elongate channel.

18. The busbar arrangement according to claim 14,
wherein the busbar is formed from copper.

19. The busbar arrangement according to claim 14, comprising:
a pump configured to pump the coolant through the busbar.

20. The busbar arrangement according to claim 14, comprising:
a heat exchanger configured to dissipate heat from the coolant.

21. The busbar arrangement according to claim 14,
wherein a passive cooling device is formed in the line system.

22. The busbar arrangement according to claim 21,
wherein the passive cooling device is configured as a heat pipe.

23. The busbar arrangement according to claim 14,
wherein the coolant is a dielectric medium.

24. The busbar arrangement according to claim 14, comprising:
an ion exchanger configured to adjust and/or reduce a conductivity of the coolant.

25. The busbar arrangement according to claim 14, comprising:
a conductivity measuring apparatus configured to measure a conductivity of the coolant.

26. A fuel cell comprising:
at least one fuel cell stack; and
at least one busbar arrangement according to claim 14,
wherein the at least one fuel cell stack is electrically connected to the busbar of the at least one busbar arrangement.
